(19) United States
(12) Patent Application Publication
(10) Pub. No.: US 2023/0351908 A1
(43) Pub. Date: Nov. 2, 2023

(54) System and Methodology Providing Dynamic Instructional Interactivity in Connection with Computer Based Applications

(71) Applicant: Newport Exchange Holdings, Inc., Irvine, CA (US)

(72) Inventors: Gabriel GERSON, Irvine, CA (US); Eyal SHACHAR, Irvine, CA (US); Eyal MARMARELI, Irvine, CA (US)

(73) Assignee: Newport Exchange Holdings, Inc., Irvine, CA (US)

(21) Appl. No.: 17/730,263

(22) Filed: Apr. 27, 2022

(51) Int. Cl. G09B 5/12; G09B 5/02; G09B 5/14

(52) U.S. Cl. CPC G09B 5/125; G09B 5/02; G09B 5/14

(57) ABSTRACT

A system and methodology which enables and enhances online instruction with respect to the use of applications. The present invention allows instructors operating in a one to many environment to logically and intuitively track and interactively assist multiple students in an online learning environment. The system and methodology of the present invention is particularly well suited to instruction with respect to complex computer-based applications in which one or more detailed processes are to be taught and where there are multiple students simultaneously seeking to learn how to interact with these processes in connection with the online application.

### FIELD OF THE INVENTION

The present invention is directed generally to systems and methodologies associated with web based applications, and, more particularly to systems and methodologies which operate to enable and enhance online instruction associated with web based applications, tools and systems.

### BACKGROUND OF THE INVENTION

Computer driven applications are prevalent in today’s world. These applications touch on a great many aspects of our lives including, how we create documents, how we schedule our appointments, how we bank and conduct other financial transactions and how we get our news. These are just a few examples and there are perhaps hundreds or thousands of other areas where these applications improve life experiences as well as business operations.

While the applications are expansive in their capabilities and functionality, many such applications do suffer from the drawback of having a steep learning curve in order to be an effective and efficient user of the application or to otherwise benefit from many of the available features. In fact, many users of these relatively complex applications may never get to the point where they can leverage the true power of the application due to the inherent complexity and difficulty in learning how to use and access various features.

Applications, in this context may refer to various instrumentalities for providing various features and functionalities. For example, these applications may be delivered as “cloud-based” solutions residing on a server remote from a user that accesses the application via a computing device such as a personal computer, tablet and/or smartphone. Alternatively, these applications may be provided in the form of downloadable software which is located and run on a the user’s local device. Other implementations are also possible as will be known and understood by one of skill in the art.

It is true that there are a number of basic applications that are not particularly feature rich. For these applications, a very simple user guide may be sufficient for the user to interact with the application in a manner which provides the user with the ability to access most or all of the available features and/or to use the application in an efficient manner. Such user guides may be provided “offline” such as in the form of a written/physical book or pamphlet. Alternatively or in addition, documentation may be available online either integral to the application itself or externally such as through readable files that user may access and review.

For these basic applications, the combination of these online and offline resources along with a user being able to “play around” in the application to learn the features and functionalities is often sufficient. However, there is also a large universe of web-based applications, for which this learning approach is not ideal. For example, applications, whether web-based, locally resident or otherwise, can be particularly complex to the extent that they are used for certain purposes or in connection with specific industries.

By way of example, certain applications in the financial industry can be extremely complex and involve a fairly lengthy learning curve before a user is reasonably competent with the application. Such applications may include accounting and tax solutions, payroll processing applications, financial management programs, stock and financial instrument trading packages, mortgage processing applications and the like. Another example is applications used by engineers such as computer aided drafting programs, structural design and analysis programs and other similar types of applications. The foregoing is merely exemplary as almost every industry and interest has available a number of robust and complex software based applications intended to enhance experiences and/or address problems associated with these industries and interests.

One manner of instructing users with respect to the use of complex applications is through in person classroom based teaching. While this method can be effective, it does suffer from some drawbacks including the expense and logistics associated with gathering a group of students and teacher(s) in one location at the same time. In addition, even in person classroom based instruction does not always work well with large groups of students seeking to learn how to use computer based applications. For example, there may only be one instructor that must walk around the room and look at each student’s computer screen to see what they are doing and, if applicable, where they need additional assistance. For complex, process oriented applications this presents a number of problems as its not reasonable to expect an instructor to personally visit each student at their location to confirm their progress at each of many steps during the overall process for accomplishing a result.

Another existing solution for engaging students in connection with their learning how to use online applications is through web based conferencing tools such as Webex, Zoom and other similar applications. The primary focus of these applications is communication so that teachers and students can interact though voice, video and chat. Some of these applications also permit screen sharing as well as offering other collaborative tools. However and even still, these solutions are not ideal with respect to instruction on how to use complex applications. Typically, only one screen can be shared so if there are many students all working on the same application, it is not feasible for the instructor to view and/or interact with each of the students with respect to that student’s particular progress and/or instructional requirements.

### SUMMARY OF THE INVENTION

It is thus a primary object of the invention to provide a system and methodology that addresses the shortcomings of the prior art as discussed above.

It is another object of the present invention to provide a system and methodology which provides a computer implemented solution which enables and enhances instructional capabilities with respect to computer based applications.

It is a further object of the present invention to provide a system and methodology which provides a computer implemented application which provides various interactive capabilities in connection with an immersive online teaching environment for the purpose of teaching individuals how to use computer based applications.

It is a still further object of the present invention to provide the foregoing system and methodology in the form of a cloud based solution.

It is a yet further object of the present invention to provide an immersive online instructional environment in which a single instructor can effectively and efficiently work with a large number of students to enable learning.

It is another object of the present invention to provide an online and interactive teaching environment in which complex processes associated with the use of computer based applications can be taught in a structured and organized fashion.

It is a yet further object of the present invention to provide a system and methodology enabling online instruction associated with the learning of computer based applications in which an instructor can manage and track student progress through various steps in a process which is being taught to the students.

It is a still further object of the present invention to provide a system and methodology enabling online instruction associated with the learning of computer based applications in which an instructor can control various aspects of student’s user interface in order to manage the teaching environment for each student individually.

A primary objective the invention disclosed herein is a system and methodology which enables and enhances online instruction with respect to the use of applications. The present invention allows instructors operating in a one to many environment to logically and intuitively track and interactively assist multiple students in an online learning environment. The system and methodology of the present invention is particularly well suited to instruction with respect to complex computer-based applications in which one or more detailed processes are to be taught and where there are multiple students simultaneously seeking to learn how to interact with these processes in connection with the online application.

The system and methodology of the present invention operate, in one embodiment, to provide a cloud based instructional platform which interacts with and/or overlays a computer based application so as to allow the instructor to interact with multiple students as the students engage with the computer based application in order to learn the features and functionality of the computer based application. Among the many unique aspects and features provided by the teachings of the present invention, the instructor may selectively take control over the user’s interaction with the computer based application so as to demonstrate the use of the computer based application.

Another unique aspect of the system and methodology of the present invention is the available of teaching modules which are available to instructors to enable teaching, tracking and demonstration associated with process oriented steps in various computer based applications being taught to many students simultaneously. The system of the present invention offers many additional features which are available to both students and instructors so as to make the teaching of the use of computer based applications informative, interactive and engaging even when the instructors and students are not physically present at the same location.

### BRIEF DESCRIPTION OF THE DRAWINGS

FIG. 1 is a diagram depicting the major components of the system of the present invention including the Interactive Teaching Engine (ITE) of the present invention in a preferred embodiment thereof;

FIG. 2 is an exemplary instructor user interface screen shot illustrating a student listing page according to the teachings of the present invention in a preferred embodiment thereof;

FIG. 2A is an exemplary instructor user interface screen illustrating a pop up window which allows an instructor to select from among a number of available views;

FIG. 3 is an exemplary instructor user interface screen shot illustrating the “walk it″/change layout functionality available to instructors according to the teachings of the present invention in a preferred embodiment thereof;

FIG. 4 is an exemplary instructor user interface screen shot illustrating the “walk it″/chart controls functionality available to instructors according to the teachings of the present invention in a preferred embodiment thereof;

FIG. 5 is a view of both an exemplary instructor screen and an exemplary student screen illustrating the ability for an instructor to manipulate screen components on the student screen dynamically and interactively according to the teachings of the present invention in a preferred embodiment thereof;

FIG. 6 is an exemplary instructor user interface screen shot illustrating the initiation of a templated activity by an instructor in an online teaching environment according to the teachings of the present invention in a preferred embodiment thereof;

FIG. 7 is an exemplary instructor user interface screen shot illustrating the initiation of a preliminary action associated with a templated activity in an online teaching environment according to the teachings of the present invention in a preferred embodiment thereof;

FIG. 8 is an exemplary student user interface screen shot illustrating a templated activity from a student point of view in an online teaching environment according to the teachings of the present invention in a preferred embodiment thereof;

FIG. 9 is a view of both an exemplary instructor screen and an exemplary student screen illustrating the initiation of a first exemplary step in carrying out the templated activities feature according to the teachings of the present invention in a preferred embodiment thereof;

FIG. 10 is a view of both an exemplary instructor screen and an exemplary student screen illustrating the sending of a video by an instructor in connection with the templated activities feature of the present invention in a preferred embodiment thereof;

FIG. 11 is an exemplary instructor user interface screen shot illustrating the initiation of the second step in a series of steps associated with a templated activity in an online teaching environment according to the teachings of the present invention in a preferred embodiment thereof; and

FIG. 12 is a view of both an exemplary instructor screen and an exemplary student screen illustrating a second exemplary step in carrying out the templated activities feature according to the teachings of the present invention in a preferred embodiment thereof.

### DETAILED DESCRIPTION OF THE INVENTION

The present disclosure will now be described in terms of various exemplary embodiments. This specification discloses one or more embodiments that incorporate features of the present embodiments. The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. The skilled artisan will appreciate that a particular feature, structure, or characteristic described in connection with one embodiment is not necessarily limited to that embodiment but typically has relevance and applicability to one or more other embodiments.

In the several figures, like reference numerals may be used for like elements having like functions even in different drawings. The embodiments described, and their detailed construction and elements, are merely provided to assist in a comprehensive understanding of the present embodiments. Thus, it is apparent that the present embodiments can be carried out in a variety of ways, and does not require any of the specific features described herein. Also, well-known functions or constructions are not described in detail since they would obscure the present embodiments with unnecessary detail.

The description is not to be taken in a limiting sense, but is made merely for the purpose of illustrating the general principles of the present embodiments, since the scope of the present embodiments are best defined by the appended claims.

It should also be noted that in some alternative implementations, the blocks in a flowchart, the communications in a sequence-diagram, the states in a state-diagram, etc., may occur out of the orders illustrated in the figures. That is, the illustrated orders of the blocks/communications/states are not intended to be limiting. Rather, the illustrated blocks/communications/states may be reordered into any suitable order, and some of the blocks/communications/states could occur simultaneously.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of′ “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items. As used herein, the singular forms “a”, “an” and “the” are intended to include the plural forms as well, unless the context clearly indicates otherwise.

The word “exemplary” is used herein to mean “serving as an example, instance, or illustration.” Any embodiment described herein as “exemplary” is not necessarily to be construed as preferred or advantageous over other embodiments. Additionally, all embodiments described herein should be considered exemplary unless otherwise stated.

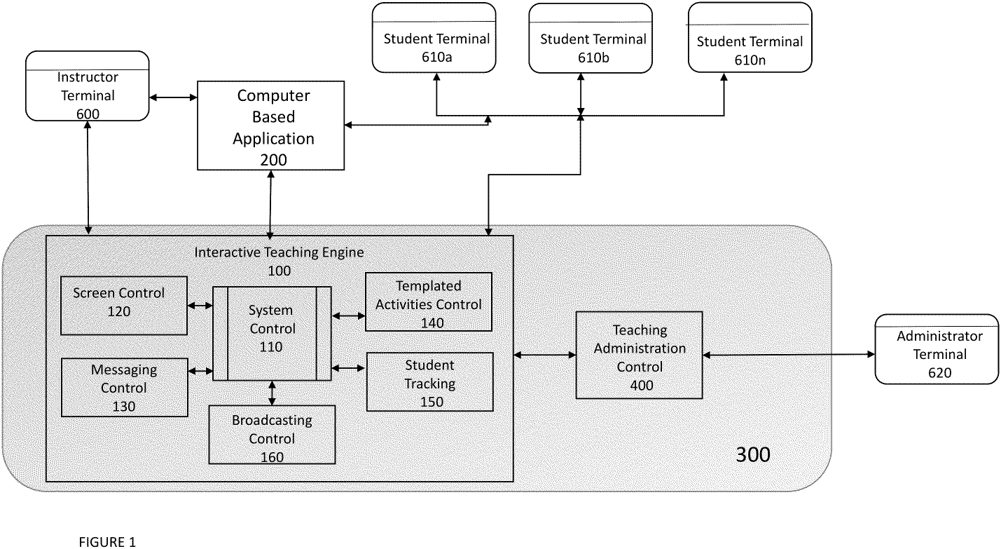

With reference now to FIG. 1, the system of the present invention, in a preferred embodiment thereof, is now described. According to a preferred embodiment, Interactive Teaching Engine (ITE) 100 and teaching administration control 400 reside on a single cloud based server 300 although it is also possible for each of ITE 100 and teaching administration control 400 to reside on separate servers. It is also possible for components of ITE 100 and/or teaching administration control 400 to themselves be distributed among multiple servers.

In any event, ITE 100 may be accessed through the internet or any other private or public network by one or more student terminals 610. Each of student terminals 610a, 610b ... 610n may be personal computers, laptops, handheld computing devices such as smartphones or tablets or any other device capable of providing the required connectivity and display. Student terminals 610 may interact with ITE 100 such that data may be communicated between them and such that ITE 100 may process program requests made by student terminals 610. In particular, ITE 100 may control the display provided by a user interface and views and components associated therewith as the same appears to a user interacting with one of student terminals 610.

Separate from this, a computer based application 200 may be used in connection with ITE 100 in a manner such that the functionality of ITE 100 “overlays” the functionality provided by computer based application 200. Computer based application 200 may be any application or computer based functionality that exists now or in the future. By way of example and not limitation, computer based application 200 could be a software program that provides features and functionalities in any industry, for some personal use or otherwise. Computer based application 200 could be, for example, a software program such as a productivity application (e.g. word processing, spreadsheet, etc.), an application used to run some aspect of a business (e.g. payroll, billing, accounting), a specialized application (e.g. music production, computer aided engineering, graphic design) or any other software application. In preferred embodiments, computer based application 200 runs on a separate server from that of server 300, although computer based application 200 may reside on server 300 in other embodiments.

Student users may interact with computer based application 200 via student terminals 610 in the normal manner. However, according to the teachings of the present invention, ITE 100 operates in connection with computer based application 200 to assist the student user in learning how to use and interact with computer based application 200. This is accomplished, in preferred embodiments, as a result of an instructor operating instructor terminal 600 to control the operation of and interaction with computer based application 200 in coordination with students using student terminals 610 to interact with computer based application 200 as more fully described herein.

As will be more fully discussed herein, there are various operating modes through which the instructor and the student interact with computer based application 200 in a coordinated fashion and under the control of ITE 100 according to the teachings of the present invention. In some cases, the instructor may take full operational control of the interaction with computer based application 200 while “locking” the student out from interacting with computer based application 200. In other cases, both the student and instructor may simultaneously interact with computer based application 200 and in yet other cases, the student may interact with computer based application 200 without any control or input by the instructor. In all of the foregoing cases, various status reporting tools and other indicators are available in connection with the system and methodologies of the present invention so as to permit the instructor to track student progress and status even in the case of one instructor teaching a large class of students all at the same time.

Also shown in FIG. 1 is teaching administration control 400 which, in preferred embodiments, is functionality which is resident on server 300 along with ITE 100 although teaching administration control could also be resident on a separate server from that of ITE 100 in some embodiments. In either case, a teaching administrator may interact with teaching administration control 400 via an administrator terminal 620. As more fully described below, an administrator may engage with teaching administration control 400 in order to receive reports and/or status updates from ITE 100 including, for example, student and/or instructor data and metrics, class information, student registration data and other data which may be associated with the teaching operation and/or the specific computer based applications 200 which are being taught using the system of the present invention.

In addition to this, and as more fully discussed below, an administrator may interact with teaching administration control 400 in order to configure ITE 100 in various ways. For example, an administrator (or instructor) working through administrator terminal 620 may design and/or update various templated activities associated with instruction with respect to one or more targeted computer based applications 200. This might be, for example, the design of a templated series of steps associated with some task to be performed using one or more computer based application 200. An exemplary use case for this is presented below in which a series of steps associated with the complex process of building a trade using a computer based stock trading application is set up within ITE 100 so as to permit students to work through these steps under the guidance of an instructor via ITE 100.

With continued reference to FIG. 1, the various sub-components of ITE 100 are now discussed at a high level with further detail regarding the operation of each such component being provided below. System control 110 manages the overall operations of ITE 100 including all processes associated therewith. System control further coordinates the interactions between and among the various components of ITE 100 and the interaction such components and the various users such as an instructor at instructor terminal 600, an administrator at administrator terminal 620 and/or students at student terminals 610.

Screen control 120 operates to allow an instructor to control various aspects and elements of the user interface screen viewed by students at student terminals 610. Control of these aspects and elements may be done on a student by student basis, among particular groupings of students, or for all students in an active class. Exemplary elements which may be controlled via the operation of screen control 120 include buttons, sliders, graphical elements and just about any other element visible and/or manipulable on the student user interface screen displayed on student terminals 610.

Messaging control component 130 of ITE 100, in some embodiments, operates to initiate and implement various messages between an instructor at instructor terminal 600 and one or more students at student terminals 610. Messaging activities may include short text messages and/or the transmission of, for example, videos, documents, audio clips, emails, diagrams, photos, animations and the like. These messages may be sent by instructors to students or vice versa and they may be sent during the teaching session in an effort to supplement the teaching environment and enable dynamic learning functionalities.

Templated activities control 140 component of ITE 100 enables a novel and unique approach to online learning in a dynamic and interactive fashion. In particular, templated activities control enables an instructor or an administrator (using either or both of instructor terminal 600 or administrator terminal 620) to develop unique learning templates which may be later used during live instruction with groups of students to enable learning of processes associated with one or more computer based applications 200. In a preferred embodiment of the present invention, an administrator or instructor may engage with administrator terminal 620, which in turn interacts with teaching administration control 400 to set up various templated activities which are later used by instructors to teach various multi-step activities associated with the use of computer based applications 200.

So, for example, in one embodiment, an instructor may develop a templated activity designed to teach students how to create a specific type of spreadsheet in a spreadsheet program (computer based application 200) such as Microsoft Excel. In this example, an instructor may wish to teach students how to set up a spreadsheet which is used to track profit and loss in a restaurant business. The templated activity is developed by the instructor using a the graphical user interface on the administrator terminal 620 including interaction with teaching administration control 400 which enables the process of setting up templated activities according to the teachings of the present invention in preferred embodiments thereof. Continuing with the example, the instructor may wish as a first step, to first teach students how to find and select the preferred spreadsheet layout. This step may be templated including one or more of the following activities, for example, associated with the step:
1) highlighting buttons and/or screen areas to show the student where to click/hover/etc. to cause the selection of the proper spreadsheet layout;
2) initiating a video/animation/audio file and/or sending a document informing how to accomplish selecting the proper spreadsheet layout;
3) initiating the instructor’s ability to enhance and modify the student’s screen so that the instructor can demonstrate the accomplishment of selecting the proper spreadsheet layout for one or more of the students;
4) taking control of the student’s screen and initiating a demonstration of how to accomplish the selection of the proper spreadsheet layout or some portion of this step so that the student can repeat the actions on his or her own after the demonstration;
5) initiating a quiz which is used to demonstrate the student’s knowledge with respect to the step of selecting the proper spreadsheet layout.

In addition to the above, various other controls and manners of guidance may be implemented through the unique activities templates functionality of the present invention. With respect to the example and the additional steps required in connection with the spreadsheet program computer based application 200 in order to develop the profit and loss spreadsheet, the same methodology described above can be created for additional steps in the process and invoked by the instructor to teach the use of the computer based application in this fashion. So, for example, the second step in the process may be to format certain of the cells in a certain way such as with respect to data alignment, data type, cell size, font size etc. As described above, the instructor or administrator may create additional templated activities to teach these additional steps in the overall process.

As will be described in more detail below, in preferred embodiments, templated activities are pre-developed using teaching administration control 400 and may be stored on server 300 for later use by an instructor during a synchronous instructional class. However, in alternative embodiments, the templated activities may be later initiated by a student for use in an asynchronous manner with or without an instructor being actively engaged at the time that the student works through the templated process.

Returning now to additional components of ITE 100, student tracking component 150 permits instructors and administrators to track student progress in various manners and with respect to various metrics. For example, student tracking component 150 may operate to allow an instructor working at instructor terminal 600 to track a student’s progress through a templated activity as described above. In such case, a custom user interface may be displayed on instructor terminal 600 allowing an instructor to view the progress of each student in the class though the multiple steps comprising an overall templated activity. In addition, student tracking component 150 may also allow instructors and administrators to view aggregated student statistics, enrollment data for students and classes, individual student registration data including coursework and degree/certification progress as well as many other aspects associated with the operation of an instructional/education providing operation.

Broadcasting control component 160 of ITE 100 manages the control of the overall display environment at student terminals 610. As will be discussed in more detail below, broadcasting control component allows instructors to select various modes of operation including screen sharing as between instructor and student(s), quick-view and full-view modes. These modes differ with respect to how the student and instructor collectively and collaboratively interact with computer based application 200 again as more fully discussed below.

Server 300 (and other servers not shown but upon which various components of the present invention may reside) may include electronic storage, one or more processors, and/or other components. The servers may also include communication lines, or ports to enable the exchange of information with a network and/or other computing platforms. The servers may include a plurality of hardware, software, and/or firmware components operating together to provide the functionality attributed herein to ITE 100, computer based application 200 and/or teaching administration control 400.

Electronic storage associated with the servers may comprise non-transitory storage media that electronically stores information. The electronic storage media of electronic storage may include one or both of system storage that is provided integrally (i.e., substantially non-removable) with servers and/or removable storage that is removably connectable to the servers via, for example, a port or a drive.

Electronic storage may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage may include one or more virtual storage resources (e.g., cloud storage, a virtual private network, and/or other virtual storage resources). Electronic storage may store software algorithms, information determined by processors, information received from servers, information received from terminals and/or other information that enables the servers to function as described herein.

While an exemplary architecture is described above, it will readily be understood by one of skill in the art that an unlimited number of architectures and computing environments are possible while still remaining within the scope and spirit of the present invention. Now that a high level description of the components and architecture associated with the system and methodology of the present invention has been provided, the specific aspects of the novel interactive and dynamic online instructional capabilities implemented by ITE 100 of the present invention is discussed.

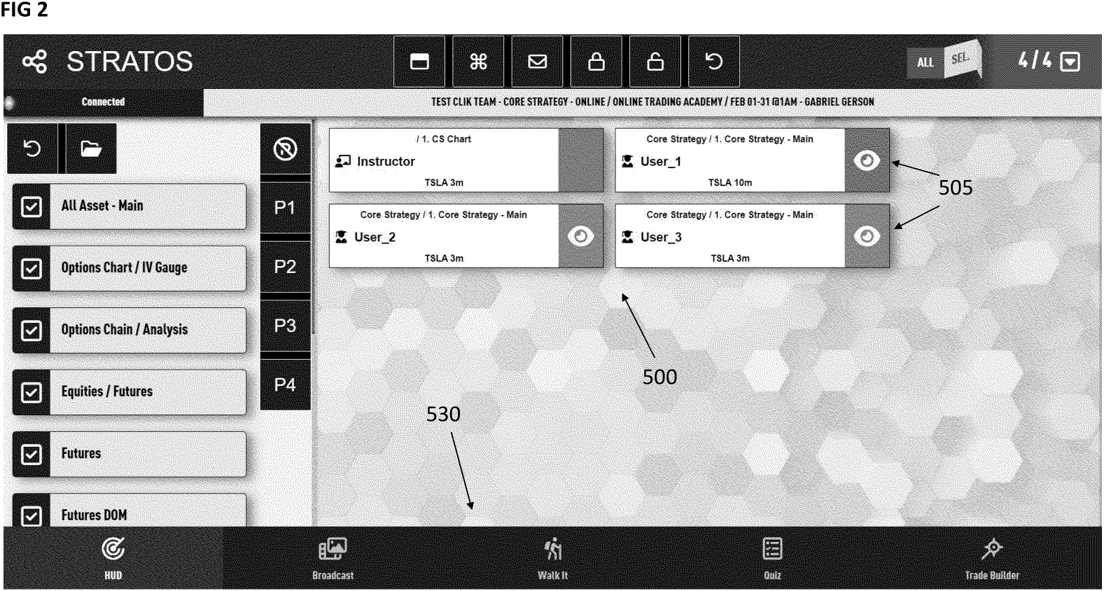

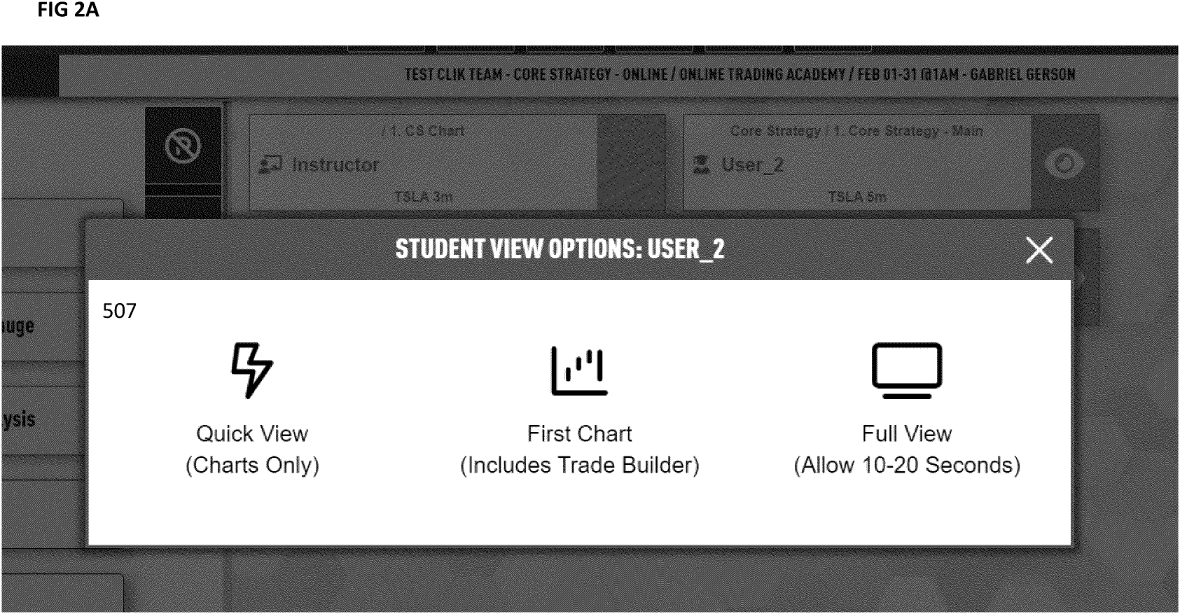

With reference now to FIG. 2, an exemplary user interface screen which may be presented on instructor terminal 600 is illustrated. In this example, the instructor may use this screen to view and interact with one or more students (“CliK users”) that are currently online and engaged in class session currently being taught by the instructor. This view may be accessed by selecting the “HUD” button on command bar 530. In this case, the display shows the instructor and three currently active students (User_1, User_2, and User_3) in viewing area 500. Additional information about each student may be provided on the buttons such as name, progress through the course, stock symbol being worked on, location etc. It is also possible to distinguish via color coding, shading etc., (indicator 505) as to student status including, for example, whether the student is trading the same or different stock or trading timeframe with respect to the instructor.

FIG. 2A illustrates a pop up screen 507 which may be displayed on the instructor screen when the instructor selects one of the student tiles. This provides the instructor with the option to interact with the presently displayed student screen in various ways. Unlike traditional screen or desktop sharing, the system of the present invention can capture the user platform screen without installing or running screen sharing applications. In order to achieve this, the system of the present invention, on the client side, breaks the screen into basic display elements, then combines them into an image, to be sent back to instructor terminal 600.

By way of example and not limitation and as shown in FIG. 2A, three different views are possible:
1) Quick View - a simple view with standard resolution for viewing charts only using a fast render;
2) First Chart - a more complex high definition view of the first chart on the student screen. This mode requires a longer render time.
3) Full View - every basic element on the screen is rendered in high definition. This requires the longest render time.

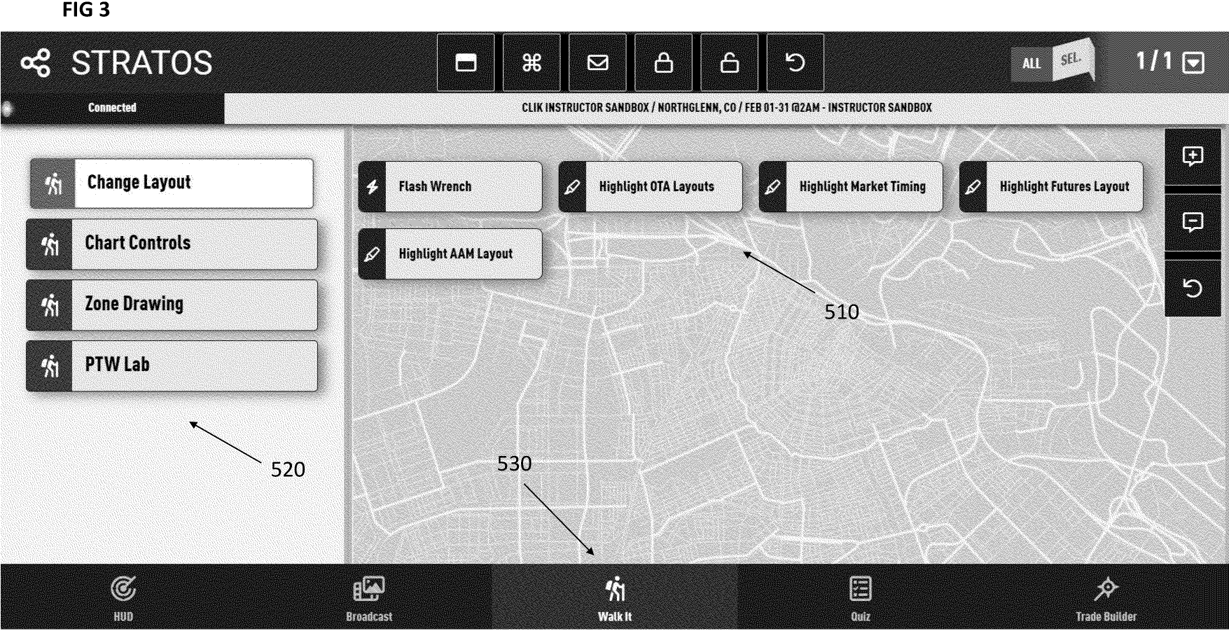

Turning now to FIG. 3, a screenshot of an exemplary instructor screen is provided in which the instructor may select from among various functionalities available to the instructor in teaching the online class. As can be seen in this example, selection bar 530 allows the instructor to choose from among the following selections: HUD, Broadcast, Walk It, Quiz and Tradebuilder. As will be readily apparent to one of skill in the art, these choices are merely exemplary and they can be customized based on the specific teaching requirements as they apply to the specific computer based application 200 being taught or otherwise. The instructor screens displayed and available to the instructors, as alluded to above, may be customized for particular teaching requirements, individual instructor preferences and/or specific computer based applications 200 via administrator terminal 620 and teaching administration control 400.

In the case of FIG. 3, the instructor has selected the “Walk It” functionality which results in the screen display as shown. Once this selection has been made, sets of available actions may be chosen via selection area 520. In this case, “Change Layout” has been selected resulting in the display of the various actions 510 available under that set of controls. Again, as will be readily apparent, the choices in selection area 520 and the various actions 510 available in connection therewith are merely exemplary and each of these may be customized as desired and as described above.

Continuing with the example, the available actions 510 are based on an example of teaching students how to use and interact with a trading program (computer based application 200) involving price/time charts, various chart patterns and the like. As such, available actions 510 relate to instructor actions in connection with the control of the layout of the displays of this trading program as an overlay to the student’s instance of the trading program (computer based application 200) as the same appears on the student terminal 610.

By selecting one of the action buttons 510, an instructor can cause an action to happen on a computer based application 200 screen for an individual student, a group of students or all students in the class. For example, an instructor might highlight the “Highlight Futures Layout” action button resulting in a specific layout presentation associated with futures trading on the screen of one or more students as displayed on the user interface of student terminal 610. Various other screen components of the computer based application 210 user interface screens may be manipulated in this and similar manners in connection with the teachings of the present invention.

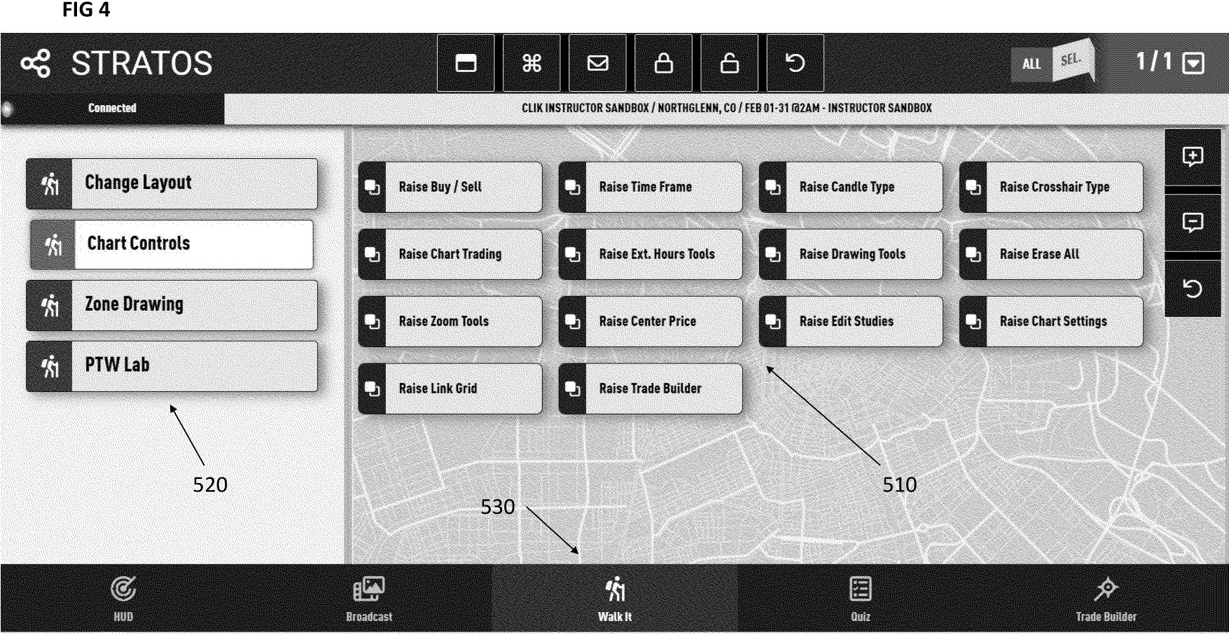

Turning now to FIG. 4, and in the case of FIG. 4, the instructor has selected the “Walk It″” functionality on selection bar 530 which results in the screen display as shown. Once this selection has been made, sets of available actions may be chosen via selection area 520. In this case, “Chart Controls” has been selected resulting in the display of the various actions 510 available under that set of controls. Again, as will be readily apparent, the choices in selection area 520 and the various actions 510 available in connection therewith are merely exemplary and each of these may be customized as desired and as described above.

Continuing with the example, the available actions 510 are based on an example of teaching students how to use and interact with a trading program (computer based application 200) involving price/time charts, various chart patterns and the like. As such, available actions 510 relate to instructor actions in connection with the displays of this trading program as an overlay to the student’s instance of the trading program (computer based application 200) as the same appears on the student terminal 610.

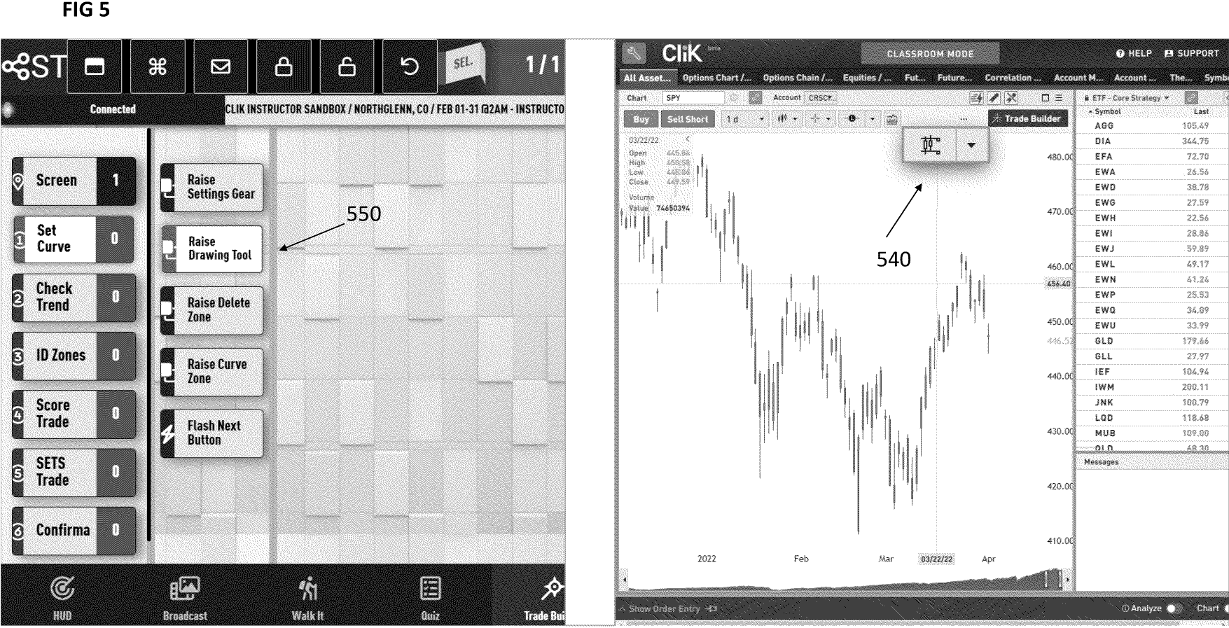

By selecting one of the action buttons 510, an instructor can cause an action to happen on a computer based application 200 screen for an individual student, a group of students or all students in the class. An example of this is provided in connection with FIG. 4, where the instructor has clicked on the “Raise Drawing Tool” action button 550 under the “Set Curve” set of actions (left screen - instructor screen) resulting in the student screen (shown on the right side of FIG. 5) drawing tool selection button 540 being “raised” (i.e. zoomed and offset). This allows the instructor to dynamically and in real time direct one or more students to specific interactive aspects of the computer based application being taught. Various other screen components of the computer based application user interface screens may be manipulated in this and similar manners in connection with the teachings of the present invention.

Returning now to FIG. 4, a description of other exemplary operations as selected by an instructor using selection bar 530 is now provided. When the instructor selects the HUD option on selection bar 530, the instructor is able to see information about students in the class as well as being able to select and interact with students. This is more fully discussed below.

When the instructor selects the Broadcast option on selection bar 530, it allows the instructor to send videos and/or images to one or more students as selected by the instructor. These videos and images may then be controlled by the instructor as such videos and images are displayed on the student’s screen. For example, the instructor can resize and/or move the video or image on the student screen. In addition, the instructor can manipulate other aspects of the display or playing of a video such as changing the volume, pausing playback and other actions that would normally be done by the person with direct control of the display screen.

When an instructor selects the Quiz option on selection bar 530, it allows the instructor to send quizzes to one or more of the students in the class. These can be short quizzes as the students progress through learning various features and functionalities associated with computer based application 210. In this way, the instructor can test student knowledge before proceeding to a next step and/or different feature associated with computer based application 210. In preferred embodiments, the instructor can see, through a graphical interface, each student’s results on the quiz so as to assess each student’s learning progress with respect to computer based application 210. This quiz functionality can also be used in connection with the templated activities aspect of the present invention as students progress through the steps in the templated process.

A particularly novel aspect of the present invention is the templated activities functionality that are available through the unique system and methodologies taught hereunder. A detailed discussion of this aspect is now provided through the use of an exemplary use case. This use case is a series of steps necessary to perform a task which comprises implementing the exemplary “Trade Builder” functionality of an exemplary trading application which comprises the computer based application 200 being taught in this example. In this case, and in order to demonstrate the templated activity functionality of the present invention, it is presumed that the instructor selects the “Trade Builder” button on selection bar 530. What follows is the instructor’s ability to teach the student(s) how to perform the series of steps to create a trade using the tradebuilder functionality provided by the trading application computer based application 200.

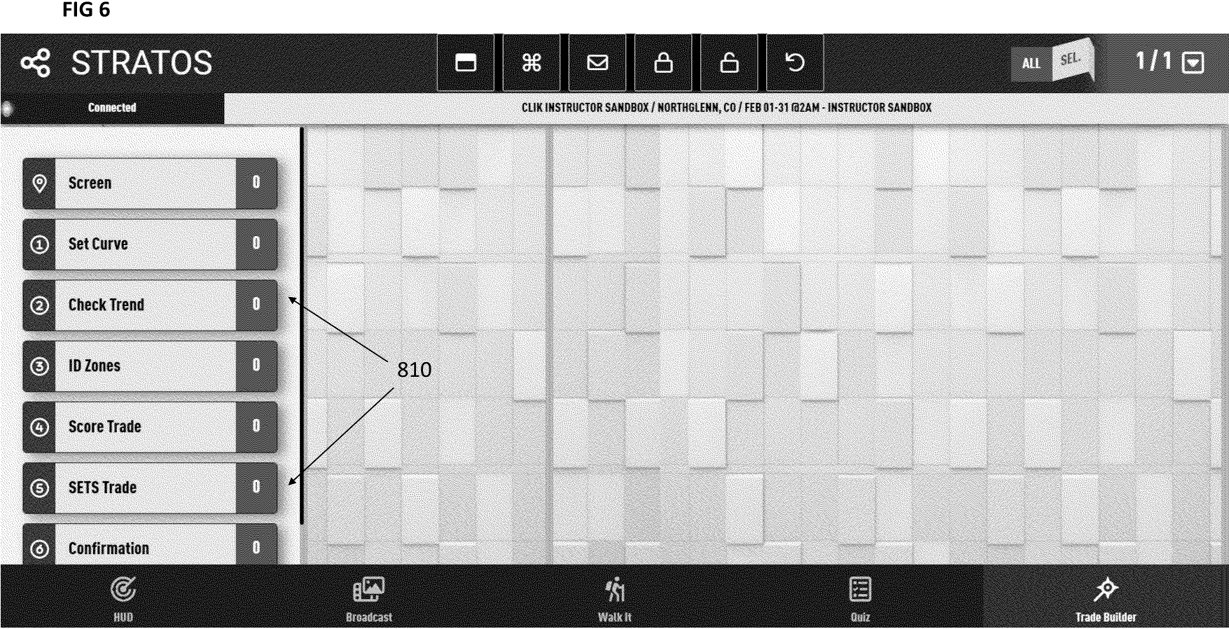

With reference now specifically to FIG. 6, an exemplary screen shot representing what an instructor might see on instructor terminal 600 in connection with initiating a templated activity, according to the teachings of the present invention, is presented. As noted above, in this example, the instructor is walking students in an online class through a series of steps necessary to achieve a desired result in connection with the use of a stock trading application computer based application 200. While the discussion will assume and reflect that the instructor is teaching multiple students in an online classroom in a synchronous manner, it will be understood by one of skill in the art that the teachings of the present invention could also be applied such that a student could learn in an asynchronous manner. One way of achieving this is through the recordation of some portion or all of a synchronous class with respect to one or more of the individual student’s view of the interactions during the class. Then, a student desiring to learn in an asynchronous format, could access one or more of these recordings in connection with his or her actual and interactive use of computer based application 200.

FIG. 6 shows an instructor screen with each of the Tradebuilder steps available through the use of selection bar 810. In this case, the top most button (“Screen”) allows the instructor to set various screen parameters as to how student’s view of the user interface for computer based application 200 appears on their screen including applicable layouts, available functionalities, selected modes and the like. This portion of the process is considered preliminary as it is not an actual part of building a trade using the Tradebuilder functionality available through the trading computer based application 200. The first actual step in the process is “Set Curve” which is the second button available in selection bar 810.

With respect to the Set Curve step, other later steps and the preliminary Screen step, the instructor may view which students are currently at that step and then individually select each of those students using icons/buttons so that the instructor can interact with that student in connection with the step that the student is on as desired. In addition, the instructor could select all of the students working on that specific step and interact with all of this group of students in the same manner (e.g. the instructor could highlight a particular button on the student’s screen associated with that step for all students simultaneously). As yet another example, the instructor could interact with all students in the class regardless of what step they are on simultaneously.

While FIG. 6 shows six steps in the process of building a trade using the Tradebuilder feature of the exemplary computer based application 200, other or additional steps could be included as either mandatory or optional. The design of the steps in the process and the availability interactions between the instructor and the students is accomplished, as discussed above, by an instructor or an administrator or both through the use of teaching administration control 400.

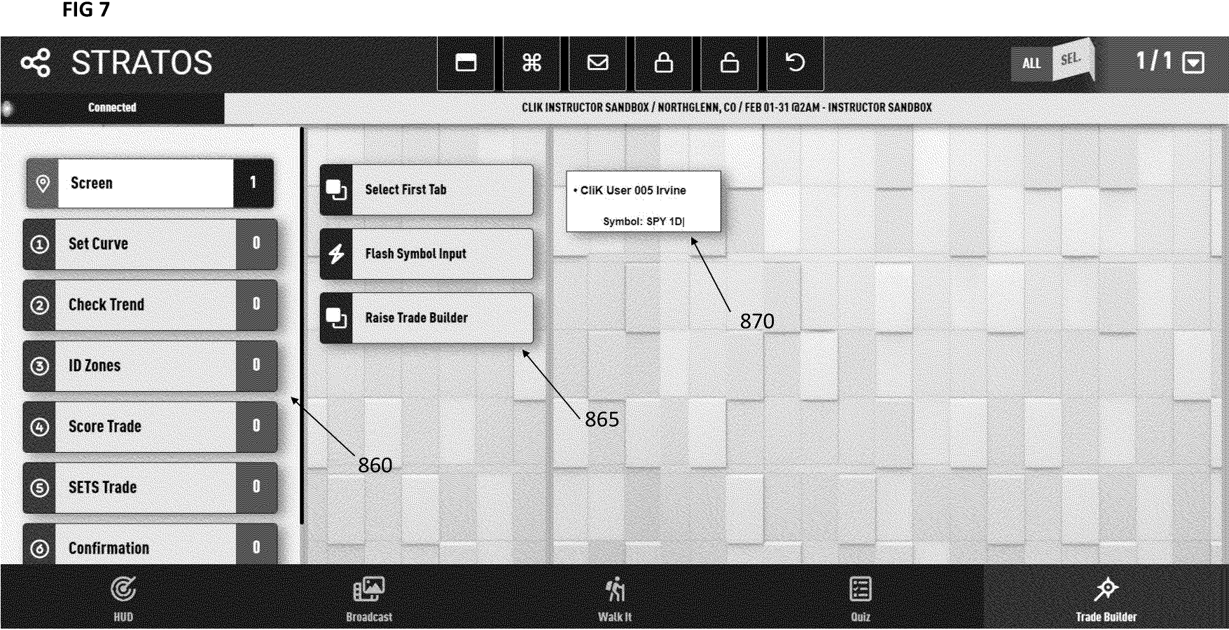

Turning now to FIG. 7, further detail regarding the operation of the instructor functionality as part of the Screen preliminary step is provided. In this case, the instructor has selected the Screen preliminary step available through selection bar 860 resulting in the display of the three available actions 865 associated with the Screen step in the overall Tradebuilder process. These actions include, for example, “select first tab”, “flash symbol input” and “raise tradebuilder”. As can be seen in FIG. 7, the instructor has elected to interact solely with student “Clik User 005 Irvine” at this point in time. The button/display indicative of which students are being interacted with 870 may also provide additional information with respect to the specific student. In this case, button/display 870 indicates that Clik User 005 Irvine is currently building a trade for the SPY symbol with a daily timeframe.

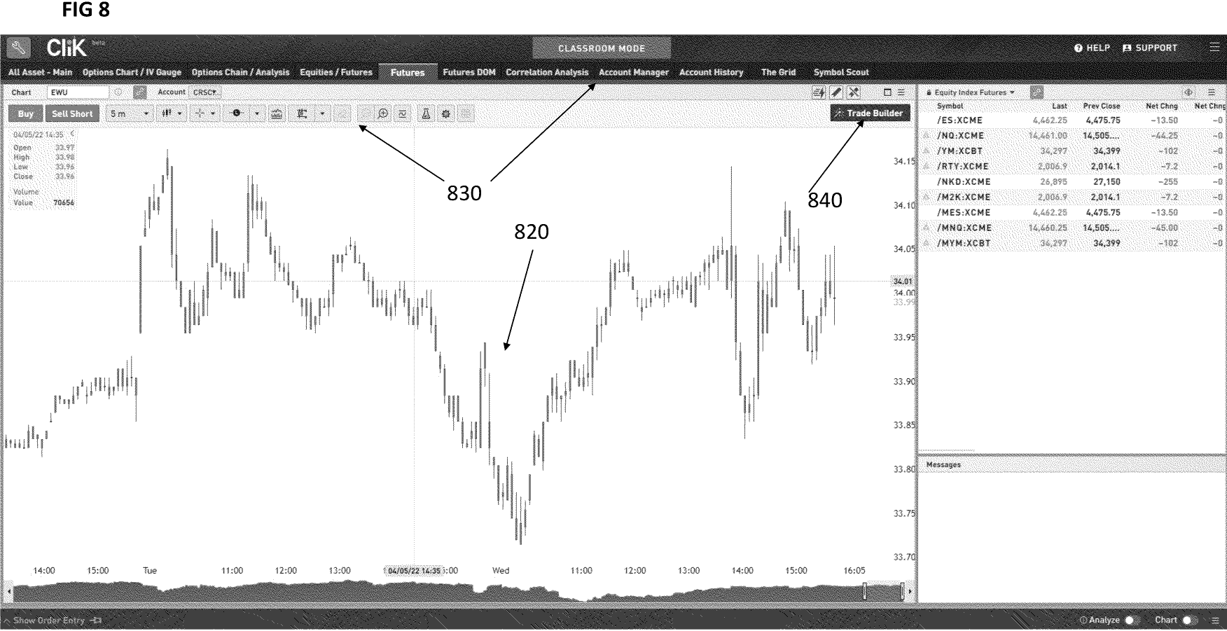

With reference to FIG. 8, an exemplary screen shot from the student point of view is provided. In this case, an instance of the stock trading computer based application 200 known as “CliK” is being used by the student. As noted, computer based application 200 may be cloud based, locally resident on student terminal 610 or otherwise remotely accessed. The user interface screen includes a number of different menus and selection bars 830 as well as an indicator 840 that the student is operating in the “Tradebuilder” mode in order to build a trade using the CliK computer based application 200. The various screen elements such as layouts, buttons, components, displays, indicators and the like on this screen may be manipulated by an instructor as described above. In this particular application, a stock price graph 820 is displayed on the screen. The charting features in the program including the stock price graph 820 may be used by both the student and the instructor in a collaborate fashion in order to teach the steps in creating a Tradebuilder trade according to the teachings of the present invention.

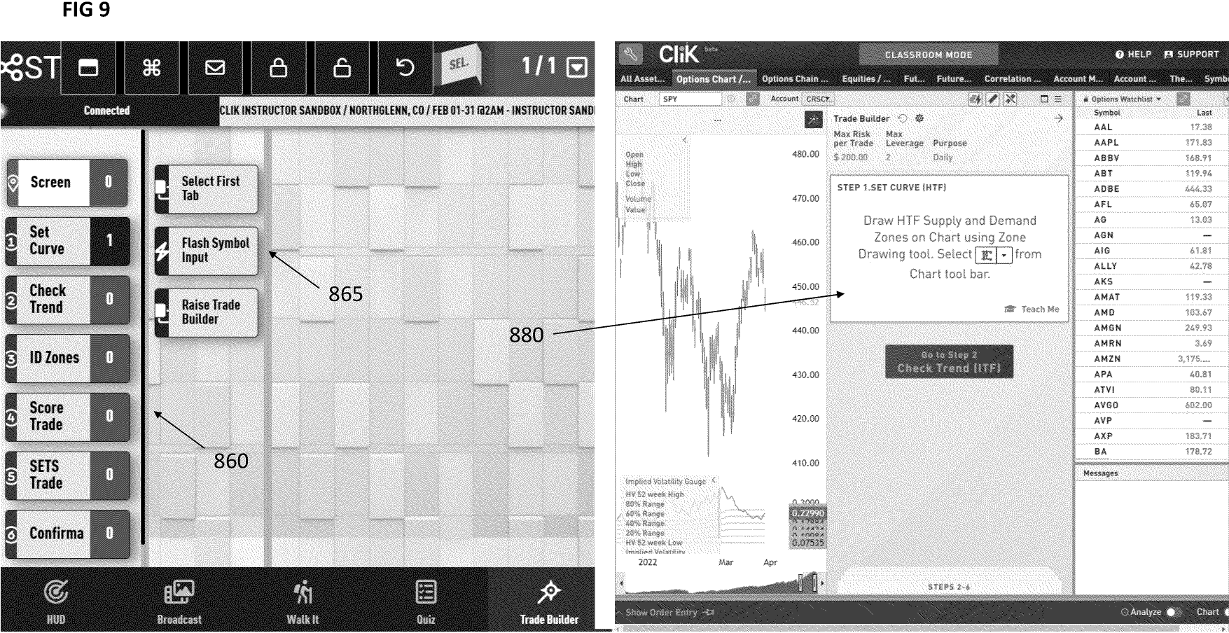

Turning now to FIG. 9, screenshots of both an instructor view (left side) and the corresponding view on student terminal 610 (right side) is provided. In this case, the instructor has just completed the Screen preliminary step to ensure that the student view is as desired. The student is moved to the first step in the Tradebuilder process (Set Curve) which is indicated in selection bar 860. In this exemplary instructor view, the “1” indicator in the Set Curve button reflects the fact that one student is at this step in the process - specifically the student who is viewing the screen at the right of FIG. 9. In a typical implementation, with multiple students in an online class, the instructor can view a screen like the one in FIG. 9 and easily see how many students are at each step in the process. The instructor can then click on any of the buttons in selection bar 860 reflecting a particular step and learn more information about the students at that step as well as selecting the group of students at that step (or just one student at that step) to interact with.

The instructor screen in FIG. 9 also includes a number of available actions 865 associated with the step being working based on the instructor selection of a step using selection bar 860. In this case, three different actions are available to the instructor. From the student standpoint (right side of FIG. 9), the set curve step has been initiated and the student is being asked to take some actions as shown in box 880. The instructor can monitor individual student interaction with the actions required in the set curve step and/or view aggregate information as to overall student progress in connection with this step.

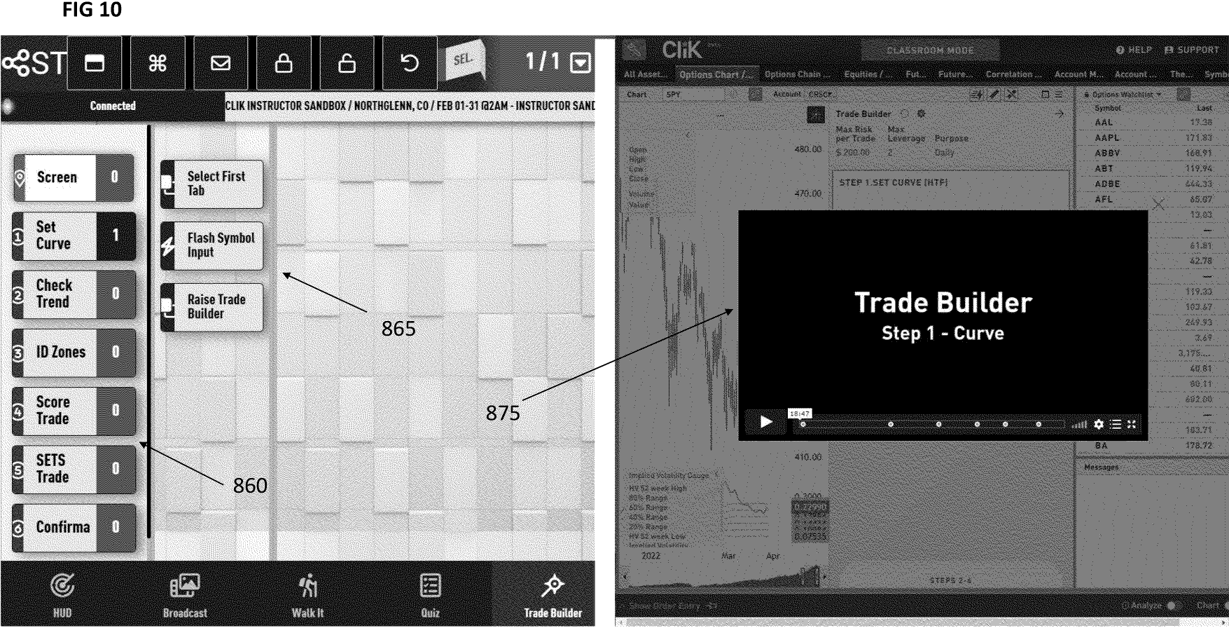

With reference now to FIG. 10, again both an instructor view and a corresponding student view is shown. FIG. 10 illustrates the ability of an instructor to “send” a video to one or more students with respect to particular step in the process being taught. In this case, the instructor has sent a video relating to the operation of the first step (set curve) for the student to review.

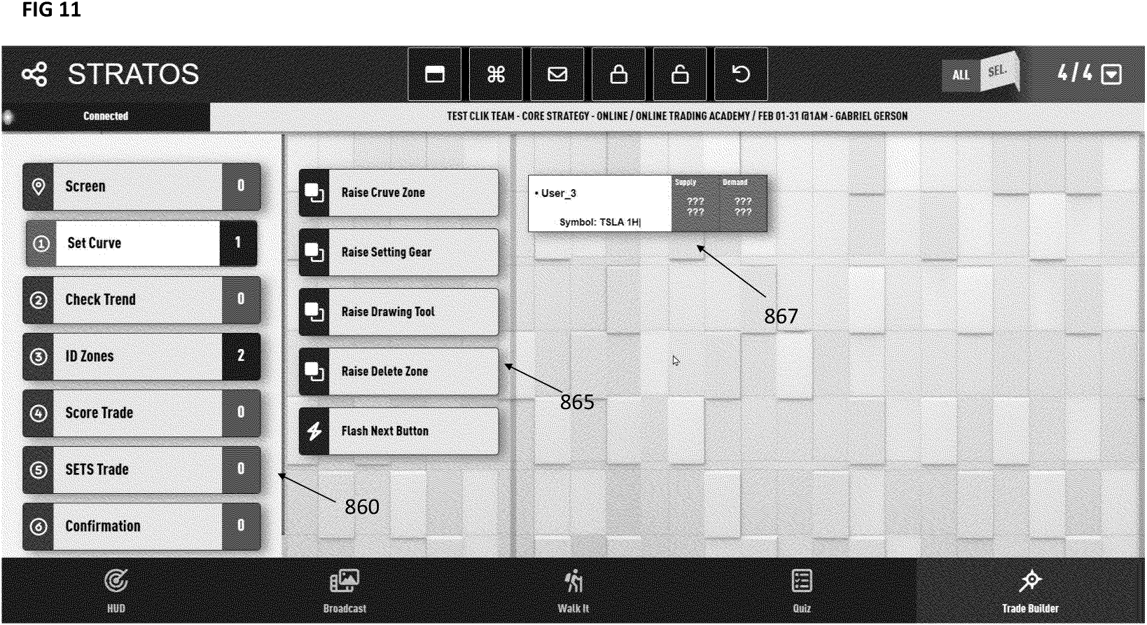

FIG. 11 is another view from the instructor perspective. In this case it can be seen that the instructor has selected the Set Curve set of available actions. This selection is made using selection bar 860 resulting in the display of the available actions 865. It can be seen that there are five available actions for the instructor to select from in connection with the set curve step. Of course, the instructor can take additional actions with respect to one or more students as well. This includes sending videos, messaging, controlling a student screen to demonstrate a task as well as many other options. Per the illustration, there is one student working on the set curve step (User_3) which is indicated by the presence of the applicable student tile 867 in the viewing area. Further, it can be seen in FIG. 11 that there is one student (User_3) currently working on the set curve step and there are two users currently working on the ID Zones step (indicated at the right of the ID Zones tile). In this way, the instructor can select among the task steps using selection bare 860 to interact with and view the students at each of the different steps.

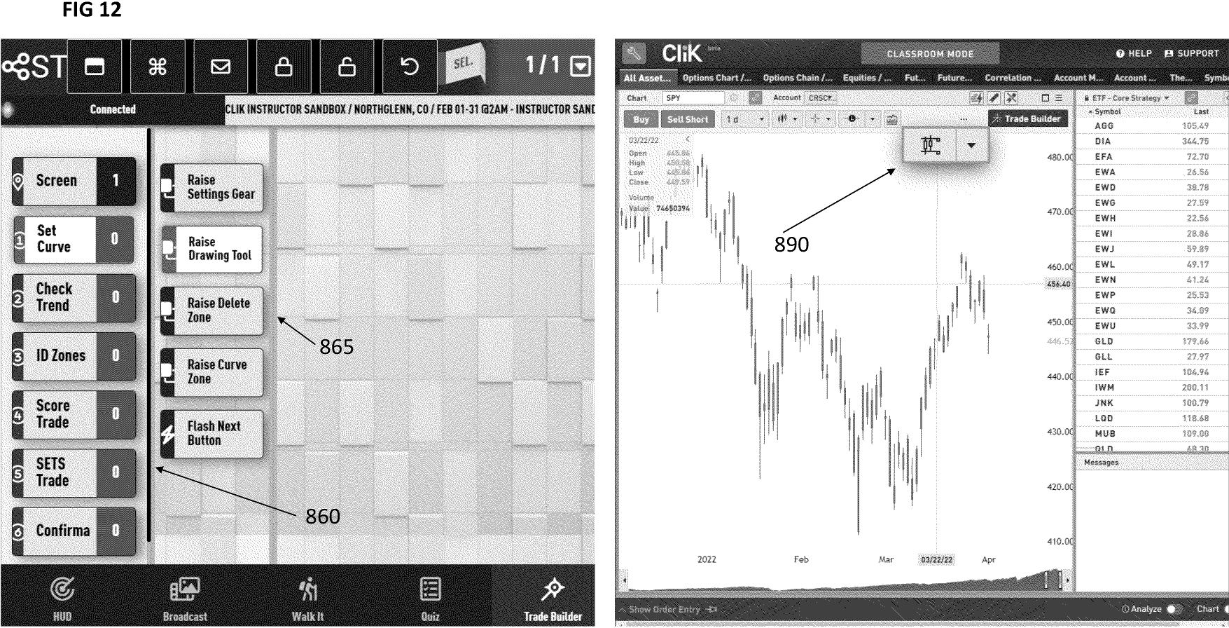

With reference now to FIG. 12, another dual view of both an instructor screen and a student screen is provided. In this Figure, it can be seen that the instructor has selected the set curve step via selection bar 860 resulting in the display of the corresponding available actions 865. The instructor has then selected the “Raise Drawing Tool” action which results in the offsetting and zooming of the drawing tool button 890 on the student screen.

While the present invention has been described primarily in the context of computer based application 200 being a stock trading application, the teachings of the present invention are by no means limited thereto and can be applied to any application, program and/or software which is used by one or more users that may vary in terms of one or more characteristics. Examples include online educational platforms, gaming applications, productivity applications such as word processors and spreadsheet applications and the like.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims.

What is claimed is:

1. A system for iteratively transforming and supplementing application content data into a form enabling enhanced learning associated with said application comprising:
a physical storage;
one or more processors operable to execute instructions being stored within said physical storage, the one or more processors further operable to:
communicate with one or more student terminals, said student terminals further communicating with an interactive teaching engine and said student terminals displaying a user interface associated with said application;
communicate with one or more instructor terminals, said instructor terminals further communicating with said interactive teaching engine and said instructor terminals displaying a user interface enabling an instructor to invoke commands causing said interactive teaching engine to enhance the user interface associated with said application as such user interface is viewed by a student using one of said student terminals;
enable at least one templated activity for instructing said student with respect to one or more tasks associated with said application wherein said templated activity comprises at least one action available to said instructor in connection with each step of a said task and wherein the invocation of said at least one action by said instructor results in at least one enhancement to the user interface associated with said application as such user interface is viewed by a student using one of said student terminals.

2. The system of claim 1 wherein said at least one action comprises the modification of at least one display element on the user interface viewed by the student.

3. The system of claim 1 wherein said at least one action comprises a real time interaction between said instructor and said application, said interaction being viewable by the student on the student terminal user interface.

4. The system of claim 1 wherein said application comprises a stock trading application.

5. The system of claim 1 wherein said application comprises a cloud based application accessed via said student terminal.

6. The system of claim 1 wherein said application is resident on a computing platform local to said student.

7. The system of claim 4 wherein said at least one action comprises the instructor drawing all or portions of stock trading zones in connection with said stock trading application.

8. The system of claim 1 wherein said templated activities are constructed by an instructor via an administrator terminal.

9. The system of claim 1 wherein said one or more processors are further operable to enable communication between said instructor and one or more students.

10. The system of claim 9 wherein said communication comprises an instructor sending a video clip to one or more students.

11. The system of claim 1 wherein said one or more processors are further operable to enable an instructor to view, for each student, the step in said at least one task at which said student is currently working.

12. A computer-implemented method of enhancing a student’s interaction with an application to assist said student in learning the operation of said application, the method being implemented in a computer system comprising one or more processors configured to execute computer program modules, the method comprising the steps of:
developing a templated activity for use in connection with said application, said templated activity being associated with a task to be performed in connection with said application and said templated activity comprising a series of steps for performing said task;
initiating the operation of said application at a student terminal;
initiating the operation of an interactive teaching engine controlled by an instructor operating an instructor terminal;
initiating said templated activity such that said instructor may engage with said interactive teaching engine to invoke one or more actions, each of said actions being associated with one step in said series of steps for performing said task in connection with said application; and
said interactive teaching engine causing one or more modifications to the user interface associated with application as said user interface appears on said student terminal.

13. The method of claim 12 wherein said one or more actions comprises the modification of at least one display element on said user interface as viewed by said student.

14. The method of claim 12 wherein said one or more actions comprise a real time interaction between said instructor and said application, said interaction being viewable by the student on said user interface.

15. The method of claim 12 wherein said application comprises a stock trading application.

16. The method of claim 12 wherein said application comprises a cloud based application accessed via said student terminal.

17. The method of claim 12 wherein said application is resident on a computing platform local to said student.

18. The method of claim 15 wherein said one or more actions comprise the instructor drawing all or portions of stock trading zones in connection with said stock trading application.

19. The method of claim 12 wherein said templated activities are constructed by an instructor via an administrator terminal.

20. The method of claim 12 further comprising the step of displaying on an instructor terminal, a view, for each student as to the step in a task at which said student is currently working.
